(19) United States
(12) Patent Application Publication
(10) Pub. No.: US 2008/0101388 A1
(43) Pub. Date: May 1, 2008

(54) GATEWAY AND METHOD FOR ADJUSTING SIGNAL INTENSITY BETWEEN A TELEPHONE AND THE GATEWAY

(75) Inventors: Hsin-Chi Lin, Tu-Cheng (TW); Shin-Hsin Hsu, Tu-Cheng (TW)

Correspondence Address: PCE INDUSTRY, INC.;ATT. CHENG-JU CHIANG J, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/617,769

(22) Filed: Dec. 29, 2006

(30) Foreign Application Priority Data
Oct. 27, 2006 (TW) 95139850

(51) Int. Cl. H04L 12/56; H04L 12/28

(52) U.S. Cl. 370/401

(57) ABSTRACT

A gateway is provided. The gateway (10), connected to a telephone (30) via a telephone network (20) includes a storage module (110), a detecting module (130), and an adjusting module (150). The storage module stores a signal intensity adjusting table, including multiple adjusting levels, and multiple adjusting values corresponding to the multiple adjusting levels respectively. The detecting module detects a tip voltage and a ring voltage of the gateway. The adjusting module computes a line impedance according to the tip voltage and the ring voltage, computes an adjusting level according the line impedance, and adjusts the signal intensity according to the adjusting value in accordance with the adjusting level by inquiring the signal intensity adjusting table. A method for adjusting signal intensity between the telephone and the gateway is also provided.

### BACKGROUND OF THE INVENTION

1. Field of the Invention

The present invention relates to network devices, and more particularly to a gateway and a method for adjusting signal intensity between a telephone and the gateway.

2. Description of Related Art

A gateway of a central office usually connects multiple telephones via a telephone network, such as a public switched telephone network (PSTN). Usually, signal attenuation between the gateway and the telephone is related to the distance therebetween. In other words, the greater the distance between the gateway and the telephone, the greater the signal attenuation between the gateway and the telephone. Therefore, if the gateway transmits signals without regard to the distance, excessive or insufficient signal intensity will occur between the telephones and the gateway.

Therefore, a heretofore unaddressed need exists in the industry to avoid excessive or insufficient signal intensity occurring between the telephones and the gateway.

### SUMMARY OF THE INVENTION

An exemplary embodiment of the invention provides a gateway. The gateway, connected to a telephone via a telephone network includes a storage module, a detecting module, and an adjusting module. The storage module stores a signal intensity adjusting table, including multiple adjusting levels, and multiple adjusting values corresponding to the multiple adjusting levels respectively. The detecting module detects a tip voltage and a ring voltage of the gateway. The adjusting module computes a line impedance according to the tip voltage and the ring voltage, computes an adjusting level according the line impedance, and adjusts the signal intensity according to the adjusting value in accordance with the adjusting level by inquiring of the signal intensity adjusting table.

Another exemplary embodiment of the invention provides a method for adjusting signal intensity between a telephone and a gateway. The method includes providing a signal intensity adjusting table, comprising multiple adjusting levels, and multiple adjusting values corresponding to the multiple adjusting levels respectively; detecting a tip voltage and a ring voltage of the gateway; computing a line impedance according to the tip voltage and the ring voltage; computing an adjusting level according the line impedance; and adjusting the signal intensity according to the adjusting value in accordance with the adjusting level, by inquiring of the signal intensity adjusting table.

Other objectives, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of a gateway in accordance with an exemplary embodiment of the present invention; and

FIG. 2 is a flowchart of a method for adjusting signal intensity between the telephone and the gateway of FIG. 1.

### DETAILED DESCRIPTION OF THE INVENTION

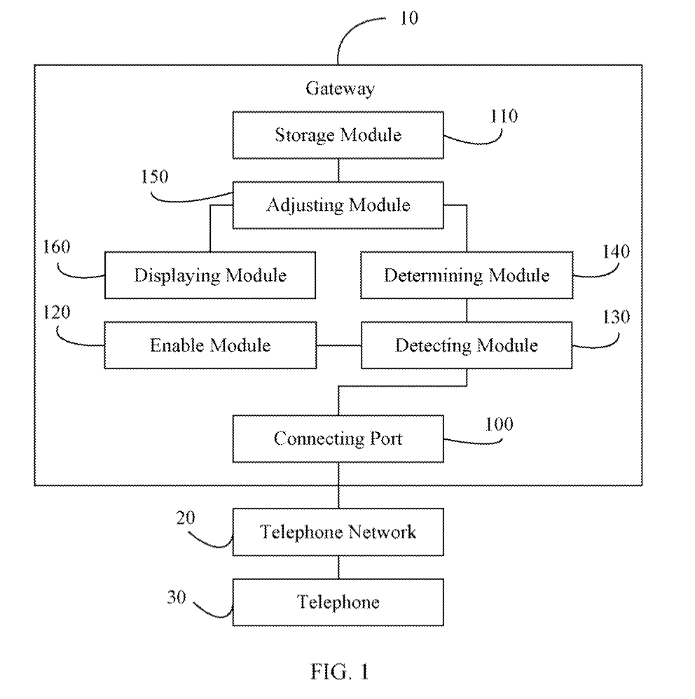

FIG. 1 is a schematic diagram of a gateway 100 in accordance with an exemplary embodiment of the present invention.

The gateway 10, connected to a telephone 30 via a telephone network 20, includes a connecting port 100, a storage module 110, an enable module 120, a detecting module 130, a determining module 140, an adjusting module 150, and a displaying module 160.

The connecting port 100 is connected to the telephone network 20 and the gateway 10. In this exemplary embodiment, the connecting port 100 is a foreign exchange service port. In other exemplary embodiments, the gateway 10 may include multiple connecting ports 100. The telephone network 20 is a public switched telephone network (PSTN), and the telephone 30 is an analog telephone.

The storage module 110 stores a signal intensity adjusting table. Table 1 is an exemplary embodiment of the signal intensity adjusting table.

TABLE 1

| | | Adjusting Values (dB) | |
|---|---|---|---|
| Adjusting | Line Length | Value from the | Value from the |
| Level | Value (meters) | Telephone to the | Gateway to the |
| / | / | Gateway | Telephone |
| 0 | 0 | 0 | −10 |
| 1 | 690 | 0 | −10 |
| 2 | 1,380 | 0 | −10 |
| 3 | 2,070 | 0 | −10 |
| 4 | 2,760 | 0 | −10 |
| 5 | 3,450 | 1 | −9 |
| 6 | 4,140 | 2 | −8 |
| 7 | 4,830 | 2 | −8 |
| 8 | 5,520 | 3 | −7 |
| 9 | 6,210 | 4 | −6 |
| 10 | 6,900 | 5 | −5 |
| 11 | 7,590 | 6 | −5 |

Table 1 includes an adjusting level field including multiple adjusting levels, a line length value field including multiple line length values, and an adjusting value field including multiple adjusting values. The multiple adjusting levels correspond to the multiple adjusting values and the multiple line length values respectively. The line length value field is incremented by 690 meters for each additional adjusting level. The line length value field includes a value from the telephone to the gateway sub-field and a value from the gateway to the telephone sub-field. For example, if the length of the communication line is 690 meters (m), the adjusting value is 1. Furthermore, if the length of the communication line between the telephone 30 and the gateway 10 is 2,760 m corresponding to an adjusting value of 3, the intensity of a signal sent from the telephone 30 to the gateway 10 should not be adjusted, but the intensity of a signal sent from the gateway 10 to the telephone 30 should be reduced 10 dB.

The enable module 120 is used for receiving a command, and turning on a signal intensity adjusting function of the gateway 10. In this embodiment, the command includes an enable command for a first time adjustment, and a renew command for further adjustments, all of which are sent from a computer.

The detecting module 130 detects a tip voltage and a ring voltage of the gateway 10. In this embodiment, the detecting module 130 is a subscriber line interface circuit (SLIC).

The determining module 140 determines states of the telephone 30 according to the tip voltage and the ring voltage. In this embodiment, the states of the telephone 30 include an off-hook state and an on-hook state. If a difference of the tip voltage and the ring voltage is greater than a pre-determined value, then the telephone 30 is in an off-hook state. Otherwise the telephone 30 is in an on-hook state. The pre-determined value is automatically set by the detecting module 130.

The adjusting module 150 computes a line impedance according to the tip voltage and the ring voltage, and computes an adjusting level according the line impedance. For example, when an impedance of the telephone 30 is 250Ω, an absolute value of the difference of the tip voltage and the ring voltage (|Vring−Vtip|) is 4.907 mV, and a loop current I between the tip and the ring is 3.097 μA. Therefore, the line impedance R=|Vring−Vtip|/I−250Ω=4.907 mV/3.097 μA−250Ω=1334Ω, and the adjusting level S=R/(r*n)=1334Ω/(295Ω/Km*0.69 Km)=6.5. In this embodiment, r=295Ω/Km, which indicates that for every 1 Km of communication line there is an impedance of 295Ω, and n=0.69 Km is a conversion factor to produce a result corresponding to the incremental values of table 1. Please note, results of calculations using the above formula are rounded to the nearest integer if a decimal fraction results, by the adjusting module 150 such as 7 for the result of 6.5 in this example, in other words the adjusting value 7 will be employed.

The adjusting module 150 further adjusts the signal intensity between the telephone 30 and the gateway 10 according to the adjusting value in accordance with the adjusting level by inquiring of the signal intensity adjusting table.

In this embodiment, in table 1, the adjusting level 7 corresponds to an increase of 2 dB in signal intensity for a signal transmitted from the telephone 30 to the gateway 10, and a decrease of −8 dB in signal intensity for signal transmitted from the gateway 10 to the telephone 30.

The displaying module 160 is used for displaying the states of the telephone 30. In this exemplary embodiment, the displaying module 160 is a light-emitting diode (LED), which continuously emits green or other colored light to indicate that the telephone 30 is in one of an on-hook state and an off-hook state. In other embodiments, the displaying module 160 may include a viewing screen.

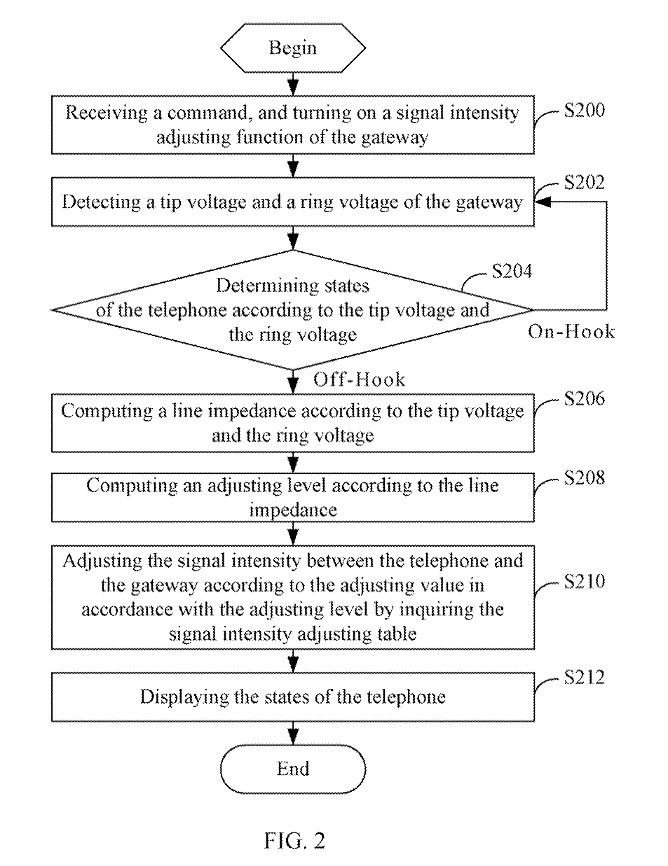

FIG. 2 is a flowchart of a method for adjusting signal intensity between the telephone 30 and the gateway 10.

In step S200, the enable module 120 receives a command, and turns on a signal intensity adjusting function of the gateway 10. In this embodiment, the command includes an enable command for a first time adjustment, and a renew command for further adjustments, all of which are sent from a computer.

In step S202, the detecting module 130 detects a tip voltage and a ring voltage of the gateway 10. In this embodiment, the detecting module 130 is a subscriber line interface circuit (SLIC).

In step S204, the determining module 140 determines states of the telephone 30 according to the tip voltage and the ring voltage. In this embodiment, the states of the telephone 30 include an off-hook state and an on-hook state. If a difference of the tip voltage and the ring voltage is greater than a pre-determined value, then the telephone 30 is in an off-hook state. Otherwise, the telephone 30 is in an on-hook state. The pre-determined value is automatically set by the detecting module 130.

If the telephone 30 is in the off-hook state, the process proceeds to step S206. If the telephone 30 is in the on-hook state, the process goes back to S202.

In step S206, the adjusting module 150 computes a line impedance according to the tip voltage and the ring voltage. In this exemplary embodiment, the line impedance R=|Vring−Vtip|/I−250Ω=4.907 mV/3.097 μA−250Ω=1334Ω.

In step S208, the adjusting module 150 computes an adjusting level according to the line impedance. In this exemplary embodiment, the example of the previous body is used and the adjusting level 7 is employed.

In step S210, the adjusting module 150 adjusts the signal intensity between the telephone 30 and the gateway 10 according to the adjusting value in accordance with the adjusting level by inquiring the signal intensity adjusting table.

In this embodiment, in table 1, the adjusting level 7 corresponds to an increase of 2 dB in signal intensity for a signal transmitted from the telephone 30 to the gateway 10, and a decrease of −8 dB in signal intensity for signal transmitted from the gateway 10 to the telephone 30.

In step S212, the displaying module 160 displays the states of the telephone 30. In this exemplary embodiment, the displaying module 160 is a light-emitting diode (LED), which continuously emits green or other colored light to indicate that the telephone 30 is in one of an on-hook state and an off-hook state.

The gateway 10 and the method of the present invention adjust the signal intensity between the telephone 30 and the gateway 10 by use of the detecting module 130, the determining module 140, and the adjusting module 150. Therefore, excessive or insufficient signal intensity will not occur between the telephone 30 and the gateway 10.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A gateway, connected to a telephone via a telephone network, comprising:
a storage module, for storing a signal intensity adjusting table, comprising multiple adjusting levels, and multiple adjusting values corresponding to the multiple adjusting levels respectively;
a detecting module, for detecting a tip voltage and a ring voltage of the gateway; and
an adjusting module, for computing a line impedance according to the tip voltage and the ring voltage, computing an adjusting level according the line impedance, and adjusting the signal intensity according to the adjusting value in accordance with the adjusting level by inquiring the signal intensity adjusting table.

2. The gateway as recited in claim 1, further comprising an enable module for receiving a command, and turning on a signal intensity adjusting function of the gateway.

3. The gateway as recited in claim 2, wherein the command comprises a enable command and a renew command.

4. The gateway as recited in claim 1, further comprising a determining module, for determining states of the telephone according to the tip voltage and the ring voltage.

5. The gateway as recited in claim 1, further comprising a displaying module, for displaying the states of the telephone.

6. The gateway as recited in claim 5, wherein the states of the telephone comprise an off-hook state and an on-hook state.

7. The gateway as recited in claim 1, further comprising a connecting port, for communication connecting the gateway to the telephone network.

8. The gateway as recited in claim 7, wherein the connecting port is a foreign exchange service port.

9. The gateway as recited in claim 1, wherein the signal intensity adjusting table further comprises a line length value corresponding to the multiple adjusting levels and the multiple adjusting values respectively.

10. The gateway as recited in claim 1, wherein the multiple adjusting values comprises at least a value from the telephone to the gateway, and a value from the gateway to the telephone.

11. A method for adjusting signal intensity between a telephone and a gateway, comprising:
providing a signal intensity adjusting table, comprising multiple adjusting levels, and multiple adjusting values corresponding to the multiple adjusting levels respectively;
detecting a tip voltage and a ring voltage of the gateway;
computing a line impedance according to the tip voltage and the ring voltage;
computing an adjusting level according to the line impedance; and
adjusting the signal intensity according to the adjusting value in accordance with the adjusting level, by inquiring of the signal intensity adjusting table.

12. The method as recited in claim 11, further comprising a step of receiving a command, and turning on a signal intensity adjusting function of the gateway.

13. The method as recited in claim 11, further comprising a step of determining states of the telephone according to the tip voltage and the ring voltage.

14. The method as recited in claim 11, further comprising a step of displaying that the telephone is in one of an on-hook state and an off-hook state.
